(19) United States
(12) Patent Application Publication
(10) Pub. No.: US 2026/0009689 A1
(43) Pub. Date: Jan. 8, 2026

(54) TEST AND CALIBRATION OF A TORQUE MEASUREMENT DEVICE

(71) Applicant: Apex Brands, Inc., Apex, NC (US)

(72) Inventors: Bin Sun, Shanghai (CN); Henglian Luo, Shanghai (CN); Tong Li, Shanghai (CN); Jingjian Qian, Suzhou (CN)

(21) Appl. No.: 18/881,944

(22) PCT Filed: Jul. 7, 2022
(86) PCT No.: PCT/CN2022/104379

§ 371 Date: Jan. 7, 2025

(51) Int. Cl. G01L 25/00; B25B 13/46; B25B 23/147

(52) U.S. Cl. CPC G01L 25/003; B25B 13/46; B25B 23/147

(57) ABSTRACT

A method is provided for calibrating a torque measurement device such as an electronic torque wrench (100) configured to produce a digital electrical signal that represents an applied torque as sequence of digital data points, and determine a torque value of the applied torque from the sequence of digital data points. The method includes reading the sequence of digital data points and the torque value from the torque measurement device (602). The method includes determining the torque measurement device is out of specification in that the torque value differs from a corresponding reference torque value by more than a threshold value (604). And in response, a calibration function is derived from the sequence of digital data points and the corresponding reference torque value (606), and the calibration function is written to the torque measurement device (608).

### TECHNOLOGICAL FIELD

The present disclosure relates generally to torque application and measurement devices and, in particular, to an apparatus for torque measurement such as an electronic torque wrench.

### BACKGROUND

Fasteners are often used to assemble performance critical components are tightened to a specified torque level to introduce a “pretension” in the fastener. As torque is applied to the head of the fastener, the fastener may begin to stretch beyond a certain level of applied torque. This stretch results in the pretension in the fastener which then holds the components together. Additionally, it is often necessary to further rotate the fastener through a specified angle after the desired torque level has been applied. A popular method of tightening these fasteners is to use a torque wrench.

Torque wrenches may be of mechanical or electronic type. Mechanical torque wrenches are generally less expensive than electronic. There are two common types of mechanical torque wrenches, beam and clicker types. In a beam type torque wrench, a beam bends relative to a non-deflecting beam in response to applied torque. The amount of deflection of the bending beam relative to the non-deflecting beam indicates the amount of torque applied to the fastener. Clicker type torque wrenches have a selectable preloaded snap mechanism with a spring to release at a specified, target torque, thereby generating a click noise to alert the operator to release force on the wrench from which the applied torque is produced.

Electronic torque wrenches tend to be more expensive than mechanical torque wrenches. Many electronic torque wrenches include a user interface with a human input device and an electronic visual display. The electronic torque wrench may receive a target torque through its user interface; and when applying torque to a fastener with an electronic torque wrench, torque readings may be indicated on the electronic visual display that relate to the pretension in the fastener due to the applied torque. The electronic torque wrench may also alert the operator to release the force on the wrench when the applied torque reaches the target torque.

A number of programs in which a torque wrench is used include periodic testing to verify the torque wrench is within specification in that the torque wrench is accurate to within a threshold value. In the event the torque wrench is deemed out of specification, the torque wrench often needs to be manually recalibrated onsite, or sent offsite to a location where the torque wrench may be recalibrated. It would therefore be desirable to have a system and method that addresses this issue, as well as other possible issues.

### BRIEF SUMMARY

Example implementations of the present disclosure are directed to an apparatus such as a torque tester or computer for calibrating an electronic torque wrench or other torque measurement device. The present disclosure includes, without limitation, the following example implementations.

Some example implementations provide an apparatus for calibrating a torque measurement device configured to produce a digital electrical signal that represents an applied torque as sequence of digital data points, and determine a torque value of the applied torque from the sequence of digital data points, the apparatus comprising: a memory configured to store computer-readable program code; and processing circuitry configured to access the memory, and execute the computer-readable program code to cause the apparatus to at least: read the sequence of digital data points and the torque value from the torque measurement device; determine the torque measurement device is out of specification in that the torque value differs from a corresponding reference torque value by more than a threshold value; and in response, derive a calibration function from the sequence of digital data points and the corresponding reference torque value; and write the calibration function to the torque measurement device.

Some example implementations provide a method of calibrating a torque measurement device configured to produce a digital electrical signal that represents an applied torque as sequence of digital data points, and determine a torque value of the applied torque from the sequence of digital data points, the method comprising: reading the sequence of digital data points and the torque value from the torque measurement device; determining the torque measurement device is out of specification in that the torque value differs from a corresponding reference torque value by more than a threshold value; and in response, deriving a calibration function from the sequence of digital data points and the corresponding reference torque value; and writing the calibration function to the torque measurement device.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIGS. 1A and 1B illustrate an electronic torque wrench, according to some example implementations of the present disclosure;

FIG. 2 is a block diagram of an apparatus for determining an applied torque, and that may correspond to the electronic torque wrench of FIG. 1, according to some example implementations;

FIG. 3 is a graph of a calibration function, according to some example implementations;

FIGS. 4 and 5 illustrate systems for calibrating a torque measurement device, according to various example implementations;

FIGS. 6A, 6B, 6C, 6D and 6E are flowcharts illustrating various steps in a method of calibrating a torque measurement device, according to various example implementations; and

FIG. 7 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

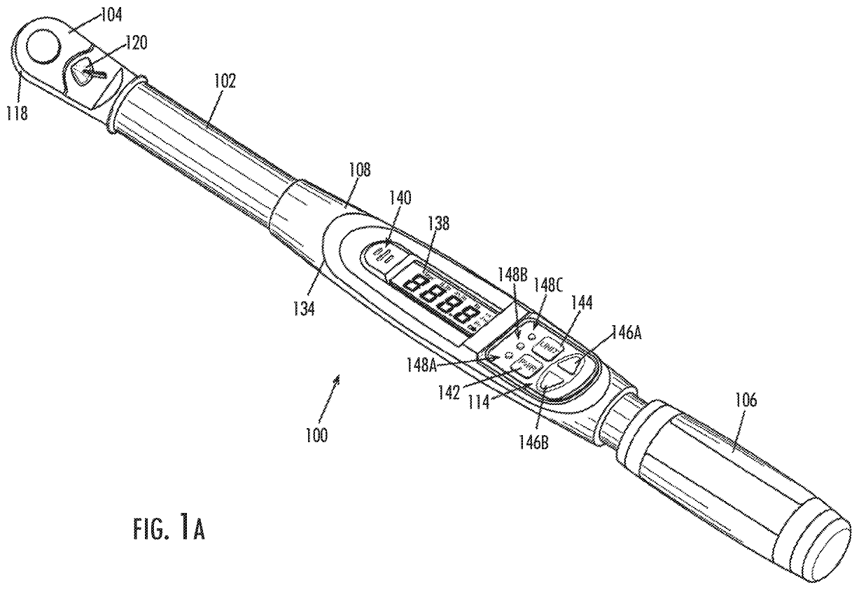

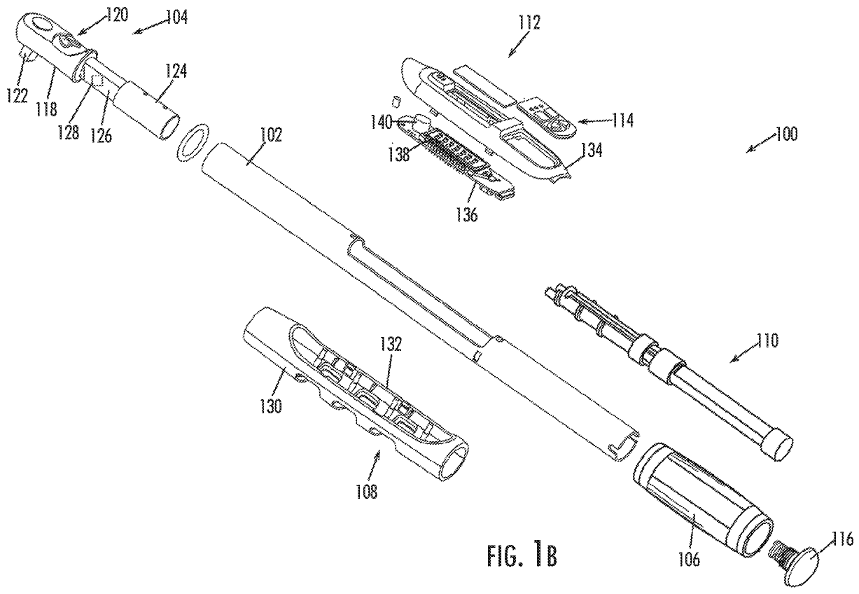

Example implementations of the present disclosure relate generally to torque application and measurement devices. Example implementations will primarily be described in the context of an electronic torque wrench. Other examples of suitable torque measurement devices include a torque tester, torque meter, torque transducer or the like. FIGS. 1A and 1B illustrate an electronic torque wrench 100 according to some example implementations of the present disclosure. As shown, the electronic torque wrench includes a wrench body 102, a wrench head 104 (e.g., a ratcheting wrench head), a grip handle 106, a housing 108, a battery assembly 110, and an electronics unit 112 with a user interface 114. In some examples, the wrench body is of tubular construction, made of steel or other rigid material, and receives the wrench head at a first end and the battery assembly at a second end, secured therein by an end cap 116. In some of these examples, the housing is mounted therebetween and carries the electronics unit.

As shown, a front end 118 of the wrench head 104 includes a coupler with a lever 120 that allows a user to select whether torque is applied to a fastener in either a clockwise (CW) or counter-clockwise (CCW) direction. The front end also includes a male square drive or boss 122 for receiving variously sized sockets, extensions, etc. A rear end 124 of the wrench head is slidably received in the wrench body 102 and rigidly secured therein. The wrench head includes at least one vertical flat portion 126 formed between the front end and the rear end for receiving a strain gauge assembly 128. The flat portion of the wrench head is both transverse to the plane of rotation of torque wrench 100 and parallel to the longitudinal center axis of the wrench head. The strain gauge assembly includes one or more strain gauges. In some examples, the strain gauge assembly is a full-bridge assembly including four separate strain gauges on a single film that is secured to the flat portion of the wrench head. Together, the full-bridge strain gauge assembly mounted on the flat portion of the wrench head is referred to as a strain tensor.

As also shown, the housing 108 includes a bottom portion 130 that is slidably received about the wrench body 104 and defines an aperture 132 for receiving a top portion 134 that carries the electronics unit 112. The electronics unit provides the user interface 114 for the operation of the electronic torque wrench 100. The electronics unit includes a circuit board 136 including a digital display 138 and an annunciator 140 mounted thereon. The portion of the housing defines an aperture that receives the user interface, which includes a power button 142, a unit selection button 144, increment/decrement buttons 146A and 146B, and three light emitting diodes (LEDs) 148A, 148B and 148C. And the LEDs may illuminate green, yellow and red, respectively, when activated.

FIG. 2 illustrates a torque measurement device 200 for determining a torque value of an applied torque, according to some example implementations. The torque measurement device may be embodied in a number of different manners, and in some examples, the torque measurement device is an electronic torque wrench such as electronic torque wrench 100. In other examples, the torque measurement device is a torque tester, torque meter, torque transducer or the like. As shown, the torque measurement device includes a strain gauge assembly 202 (e.g., strain gauge assembly 128), an amplifier 204, an analog-to-digital converter (ADC) 206, and processing circuitry 208. In some examples in which the torque measurement device 200 corresponds to electronic torque wrench 100, the amplifier ADC and processing circuitry may be components of the electronics unit 112, carried by the circuit board 136.

The strain gauge assembly 202 is configured to measure an applied torque such as the torque applied to a fastener when the torque measurement device 200 is an electronic torque wrench, and produce an analog electrical signal that varies in voltage with the torque. The amplifier 204 is configured to receive the analog electrical signal, and increase an amplitude of the analog electrical signal to produce an amplified, analog electrical signal.

The ADC 206 is configured to convert the amplified, analog electrical signal to an equivalent digital electrical signal. The processing circuitry 208, then, is configured to determine the torque value of the torque applied to the fastener from the equivalent digital electrical signal, and output an indication of the torque value. In some examples, the equivalent digital electrical signal includes digital data points; and in some of these examples, the processing circuitry is configured to determine a subset of the digital data points in a moving sample window, and calculate the torque value from a rolling average of the subset of the digital data points in the moving sample window.

The processing circuitry 208 may output the indication of the torque value in a number of different manners. In some examples, the torque measurement device 200 further includes a digital display 210 (e.g., digital display 138), and the processing circuitry is configured to output the indication of the torque value to the digital display that is configured to display the torque value.

As also shown, the torque measurement device 200 may include a communication interface 212 is configured to enable the torque measurement device to telecommunicate with another apparatus by wire, or wirelessly by radio or optical communication. As described herein, the communication interface is an electronic circuit; and in various examples, the communication interface includes a cable connector, an antenna or optoelectronics for the electronic transmission of information over a data link between the apparatus and computer/computer hardware. Examples of suitable communication interfaces include a network interface controller (NIC), wireless NIC (WNIC) or the like.

To further illustrate calculation of the torque value according to various example implementations, consider an example in which the processing circuitry 208 samples one thousand digital data points per second and uses a moving sample window of ten milliseconds. As torque is applied, the processing circuitry may average the first ten digital data points, one taken each millisecond, thereby producing a first equivalent digital value at time t=0.01 seconds, wherein t=0.0 seconds marks initiation of the torquing operation. At time t=0.011 seconds, the processing circuitry may average the digital data points taken between times t=0.002 and t=0.011 seconds, thereby producing a second equivalent digital value. At time t=0.012 seconds, the processing circuitry may average the digital data points taken between times t=0.003 seconds and t=0.012 seconds, thereby producing a third equivalent digital value. And this may continue such that an equivalent digital value may be provided every millisecond until the torque is no longer applied. In short, the processing circuitry may utilize a digital filtering algorithm to provide a rolling average in which the oldest digital data point is dropped each time a new digital data point is received within the moving sample window.

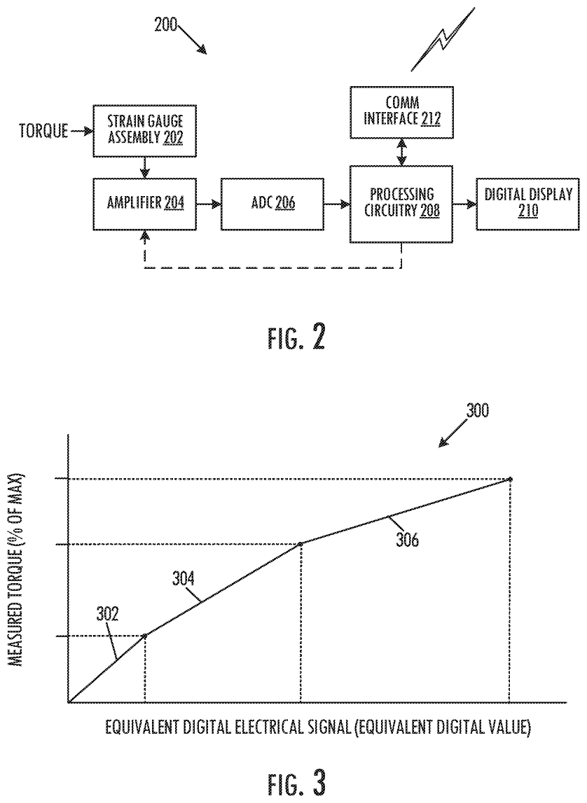

In some examples, the processing circuitry 208 may utilize the equivalent digital values and a calibration function to calculate the torque value. FIG. 3 is a graph 300 of a calibration function that includes a plurality of line segments for use by the processing circuitry to convert the digital values of the equivalent digital electrical signals into equivalent torque values, according to some example implementations. In this regard, after assembly, each torque measurement device 200 may be calibrated in order to derive the calibration function. The torque measurement device may be used to measure known applied torque values at various points along an interval of torque values ranging from 0 to 100% of a preset maximum torque. The data points for the interval of torque values provide three different line segments (302, 304 and 306) of the graph of which the slopes (m) and y-intercepts (b) can be found using the equation y=m(x)+b. The calibration function may be defined to include the linear functions for the line segments, which may be stored in memory and used by the processing circuitry to determine equivalent torque values based on the equivalent digital values.

As explained in the background section, programs that use an electronic torque wrench often test to verify its accuracy is within specification. In the event the electronic torque wrench is deemed out of specification, the electronic torque wrench often needs to be manually recalibrated onsite, or sent offsite to a location where the torque wrench may be recalibrated. Example implementations of the present disclosure provide a system and method whereby an electronic torque wrench or other torque measurement device may be tested and recalibrated at once, and for which the recalibration may be automatically performed using a sequence of digital data points and torque value read from the electronic torque wrench.

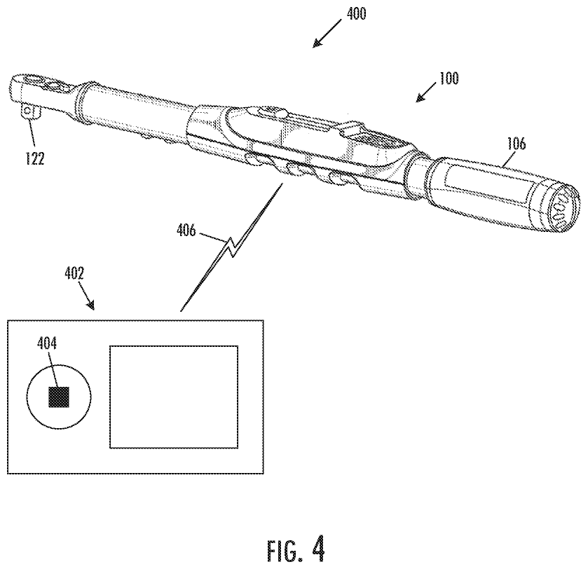

FIG. 4 illustrates a system 400 for calibrating a torque measurement device 200 such as an electronic torque wrench 100, according to various example implementations. According to various example implementations, the system includes the the torque mesaurement device and an apparatus for calibrating the torque measurement device. The apparatus may be embodied in a number of different manners. In the example shown in FIG. 4 in which the torque measurement device is an electronic torque wrench, the apparatus is embodied as a torque tester 402 that the electronic torque wrench is configured to engage. In this regard, the torque tester may include a female square drive or recess 404 configured to receive the boss 122 of the electronic torque wrench.

During calibration, the electronic torque wrench 100 is engaged with the torque tester 402 and a rotational force is applied at the grip handle 106, which produces an applied torque at the torque tester. The electronic torque wrench is configured to produce a digital electrical signal that represents the applied torque as sequence of digital data points, and determine the torque value of the applied torque from the sequence of digital data points. The torque tester is configured to read the sequence of digital data points and the torque value from the electronic torque wrench, such as over a (wired or wireless) data link 406 between the electronic torque wrench and the torque tester 402. The torque tester is configured to determine the electronic torque wrench is out of specification in that the torque value differs from a corresponding reference torque value by more than a threshold value. In some examples, the torque tester is configured to measure the torque at the torque tester, and determine the corresponding reference torque value from the torque as measured at the torque tester, such as in a manner the same as or similar to the electronic torque wrench.

In response to the determination that the electronic torque wrench 100 is out of specification, the torque tester 402 is configured to derive a calibration function from the sequence of digital data points and the corresponding reference torque value. The torque tester may then write the calibration function to the electronic torque wrench, such as over the data link 406 between the electronic torque wrench and the torque tester.

In some examples, the electronic torque wrench 100 is configured to determine the torque value from a first calibration function, and the calibration function as derived is a second calibration that is written to the electronic torque wrench on which the first calibration is overwritten by the second calibration function. And in some further examples, as described above, the electronic torque wrench is configured to convert the sequence of digital data points to a digital value, and determine the torque value from the first calibration function that maps the digital value to the torque value. Similarly, in some examples, the torque tester 402 is configured to convert the sequence of digital data points to a digital value, and derive the calibration function that maps the digital value to the corresponding reference value. More particularly, the torque tester may determine a subset of the digital data points in a moving sample window, and calculate the digital value from a rolling average of the subset of the digital data points in the moving sample window.

In some examples, the sequence of digital data points and the torque value are read for a plurality of applied torques across a rated torque range of the electronic torque wrench 100. In some of these examples, the calibration function is derived from the sequence of digital data points and corresponding reference torque values for the plurality of applied torques. This may result in a calibration function defined to include the linear functions for a plurality of line segments, such as that shown in FIG. 3 and described above.

FIG. 5 illustrates a system 500 for calibrating a torque measurement device

200 such as an electronic torque wrench 100, according to other example implementations. The system 500 is similar to the system 400 of FIG. 4; but in the system 500, the apparatus for calibrating the torque measurement device is embodied as a computer 502. Examples of suitable computers include personal computers (PCs), handheld computers, mobile phones), remote controls or the like. Examples of handheld computers include mobile computers such as tablet computers, laptops and the like, mobile phones such as smartphones, wearable computers such as smartwatches, and the like.

In various examples, the system 500 in FIG. 5 is configured to operate similar to the system 400, but with the computer 502 configured to read the sequence of digital data points and the torque value from the electronic torque wrench 100. In some of these examples, the computer is also configured to read the corresponding reference torque value from the torque tester at which the corresponding reference torque value is determined from the torque applied by the electronic torque wrench to the torque tester 402. In this regard, the sequence of digital data points and the torque value may be read over a (wired or wireless) first data link 504 between the electronic torque wrench and the computer, and the corresponding reference torque value may be read from the torque tester a (wired or wireless) second data link 506 between the torque tester and the computer.

In the system 500 of FIG. 5, the computer 502 is configured to determine the electronic torque wrench 100 is out of specification in that the torque value differs from the corresponding reference torque value (from the torque tester 402) by more than the threshold value. In response, the computer is configured to derive a calibration function from the sequence of digital data points and the corresponding reference torque value. The computer is then configured to write the calibration function to the electronic torque wrench, such as over the first data link 504 between the electronic torque wrench and the computer.

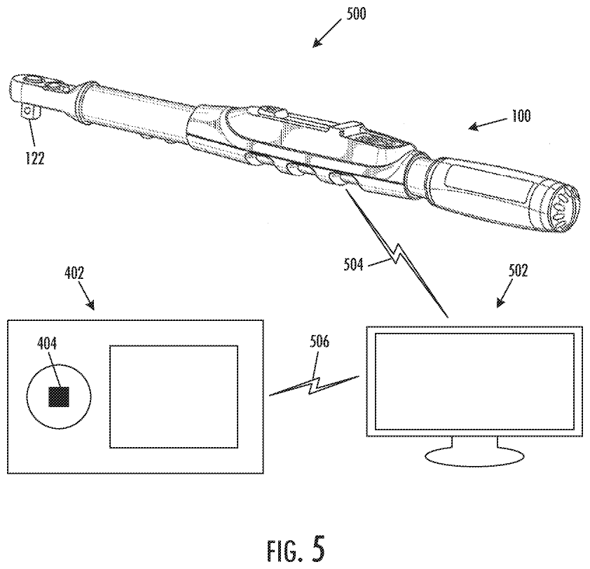

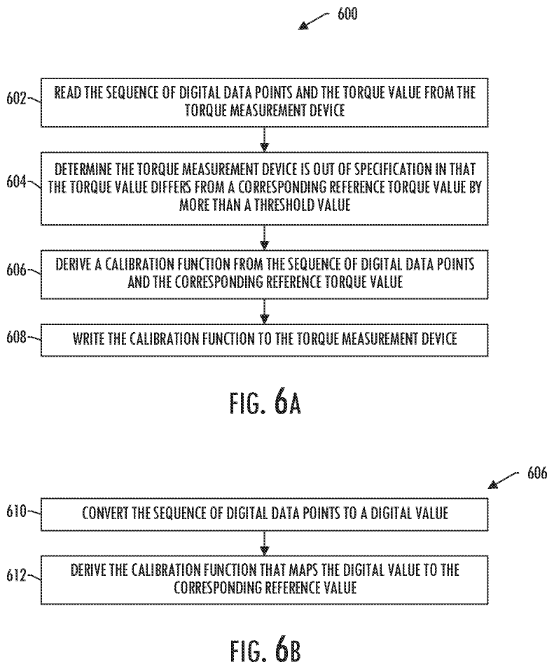

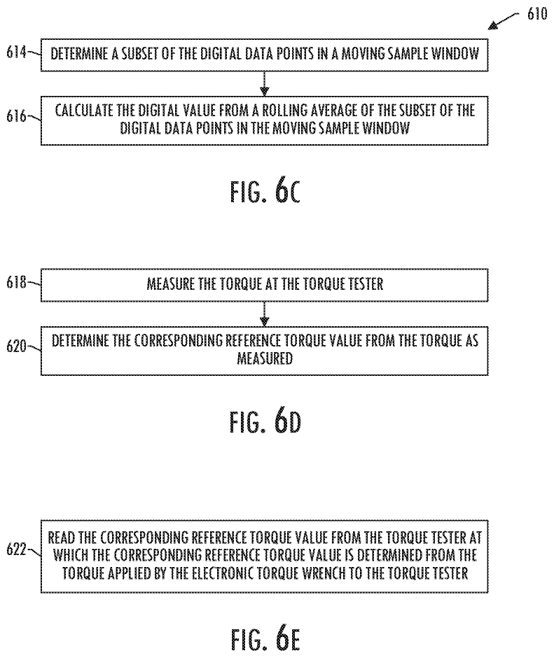

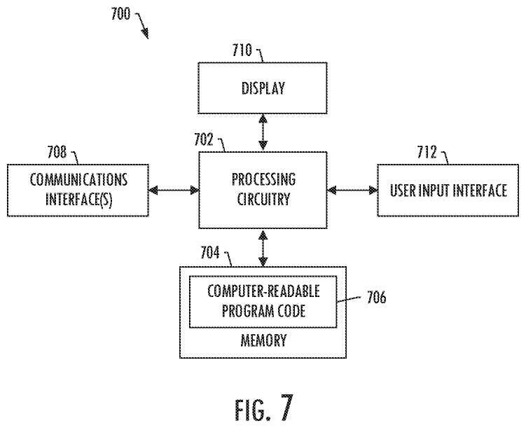

FIGS. 6A-6E are flowcharts illustrating various steps in a method 600 of calibrating a torque measurement device, according to various example implementations. The torque measurement device is configured to produce a digital electrical signal that represents an applied torque as sequence of digital data points and determine a torque value of the applied torque from the sequence of digital data points. The method includes reading the sequence of digital data points and the torque value from the torque measurement device, as shown at block 602 of FIG. 6A. The method includes determining at block 604 the torque measurement device is out of specification in that the torque value differs from a corresponding reference torque value by more than a threshold value. In response, the method includes deriving a calibration function from the sequence of digital data points and the corresponding reference torque value, as shown at block 606. And the method includes writing the calibration function to the torque measurement device, as shown at block 608.

In some examples, the torque measurement device is configured to determine the torque value from a first calibration function, and the calibration function as derived at block 606 is a second calibration that is written at block 608 to the torque measurement device on which the first calibration is overwritten by the second calibration function.

In some examples, the torque measurement device configured to determine the torque value includes the torque measurement device configured to convert the sequence of digital data points to a digital value, and determine the torque value from the first calibration function that maps the digital value to the torque value.

In some examples, deriving the calibration function at block 606 includes converting the sequence of digital data points to a digital value, as shown at block 610 of FIG. 6B. And the method includes deriving the calibration function that maps the digital value to the corresponding reference value, as shown at block 612.

In some examples, converting the sequence of digital data points at block 610 includes determining a subset of the digital data points in a moving sample window, as shown at block 614 of FIG. 6C. And the method includes calculating the digital value from a rolling average of the subset of the digital data points in the moving sample window, as shown at block 616.

In some examples, the sequence of digital data points and the torque value are read at block 602 for a plurality of applied torques across a rated torque range of the torque measurement device, and the calibration function is derived at block 606 from the sequence of digital data points and corresponding reference torque values for the plurality of applied torques.

In some examples, the torque measurement device is an electronic torque wrench, the applied torque is a torque applied by the electronic torque wrench to a torque tester with which the electronic torque wrench is engaged, and the method is performed by the torque tester.

In some examples, the sequence of digital data points and the torque value are read at block 602 from the electronic torque wrench, and the calibration function is written at block 608 to the electronic torque wrench, over a data link between the electronic torque wrench and the torque tester.

In some examples, the method 600 further includes measuring the torque at the torque tester, as shown at block 618 of FIG. 6D. And the method includes determining the corresponding reference torque value from the torque as measured, as shown at block 620.

In some examples, the torque measurement device is an electronic torque wrench, the applied torque is a torque applied by the electronic torque wrench to a torque tester with which the electronic torque wrench is engaged. The method 600 further includes reading the corresponding reference torque value from the torque tester at which the corresponding reference torque value is determined from the torque applied by the electronic torque wrench to the torque tester, as shown at block 622 of FIG. 6E.

In some examples, the method is performed by a computer, the sequence of digital data points and the torque value are read at block 602 from the electronic torque wrench, and the calibration function is written at block 608 to the electronic torque wrench, over a first data link between the electronic torque wrench and the computer. In some of these examples, the corresponding reference torque value is read at block 622 from the torque tester, over a second data link between the torque tester and the computer.

According to example implementations of the present disclosure, the apparatus (e.g., torque tester 402, computer 502) for calibrating a torque measurement device (e.g., electronic torque wrench 100) may be implemented by various means. Means for implementing the apparatus may include hardware, alone or under direction of one or more computer programs from a computer-readable storage medium. In some examples, one or more apparatuses may be configured to function as or otherwise implement the apparatus shown and described herein. In examples involving more than one apparatus, the respective apparatuses may be connected to or otherwise in communication with one another in a number of different manners, such as directly or indirectly via a wired or wireless network or the like.

FIG. 7 illustrates an apparatus 700 that may be configured to at least partially implement the torque tester 402 or computer 502, according to some example implementations of the present disclosure. Generally, an apparatus of exemplary implementations of the present disclosure may comprise, include or be embodied in one or more fixed or portable electronic devices. The apparatus may include one or more of each of a number of components such as, for example, processing circuitry 702 connected to a memory 704.

The processing circuitry 702 of example implementations of the present disclosure may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). In more particular examples, the processing circuitry may be embodied as or include a processor, coprocessor, controller, microprocessor, microcontroller, application specific integrated circuit (ASIC), field programmable gate array (FPGA) or the like.

The memory 704 is generally any piece of computer hardware that is capable of storing information such as, for example, data, computer programs (e.g., computer-readable program code 706) and/or other suitable information either on a temporary basis and/or a permanent basis. The memory may include volatile and/or non-volatile memory, and may be fixed or removable. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory 704, the processing circuitry 702 may also be connected to one or more interfaces for displaying, transmitting and/or receiving information. The interfaces may include a communications interface 708 (e.g., communications unit) and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a NIC, WNIC or the like.

The user interfaces may include a display 710 and/or one or more user input interfaces 712 (e.g., input/output unit). The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like.

As explained above and reiterated below, the present disclosure includes, without limitation, the following example implementations.

Clause 1. An apparatus for calibrating a torque measurement device configured to produce a digital electrical signal that represents an applied torque as sequence of digital data points, and determine a torque value of the applied torque from the sequence of digital data points, the apparatus comprising: a memory configured to store computer-readable program code; and processing circuitry configured to access the memory, and execute the computer-readable program code to cause the apparatus to at least: read the sequence of digital data points and the torque value from the torque measurement device; determine the torque measurement device is out of specification in that the torque value differs from a corresponding reference torque value by more than a threshold value; and in response, derive a calibration function from the sequence of digital data points and the corresponding reference torque value; and write the calibration function to the torque measurement device.

Clause 2. The apparatus of clause 1, wherein the torque measurement device is configured to determine the torque value from a first calibration function, and the calibration function as derived is a second calibration that is written to the torque measurement device on which the first calibration is overwritten by the second calibration function.

Clause 3. The apparatus of clause 2, wherein the torque measurement device configured to determine the torque value includes the torque measurement device configured to convert the sequence of digital data points to a digital value, and determine the torque value from the first calibration function that maps the digital value to the torque value.

Clause 4. The apparatus of any of clauses 1 to 3, wherein the apparatus caused to derive the calibration function includes the apparatus caused to: convert the sequence of digital data points to a digital value; and derive the calibration function that maps the digital value to the corresponding reference value.

Clause 5. The apparatus of clause 4, wherein the apparatus caused to convert the sequence of digital data points includes the apparatus caused to: determine a subset of the digital data points in a moving sample window; and calculate the digital value from a rolling average of the subset of the digital data points in the moving sample window.

Clause 6. The apparatus of any of clauses 1 to 5, wherein the sequence of digital data points and the torque value are read for a plurality of applied torques across a rated torque range of the torque measurement device, and the calibration function is derived from the sequence of digital data points and corresponding reference torque values for the plurality of applied torques.

Clause 7. The apparatus of any of clauses 1 to 6, wherein the torque measurement device is an electronic torque wrench, the applied torque is a torque applied by the electronic torque wrench to a torque tester with which the electronic torque wrench is engaged, and the apparatus is embodied as the torque tester.

Clause 8. The apparatus of clause 7, wherein the sequence of digital data points and the torque value are read from the electronic torque wrench, and the calibration function is written to the electronic torque wrench, over a data link between the electronic torque wrench and the torque tester.

Clause 9. The apparatus of clause 7 or clause 8, wherein the processing circuitry is configured to execute the computer-readable program code to cause the apparatus to further at least: measure the torque at the torque tester; and determine the corresponding reference torque value from the torque as measured.

Clause 10. The apparatus of any of clauses 1 to 9, wherein the torque measurement device is an electronic torque wrench, the applied torque is a torque applied by the electronic torque wrench to a torque tester with which the electronic torque wrench is engaged, and the processing circuitry is configured to execute the computer-readable program code to cause the apparatus to further at least: read the corresponding reference torque value from the torque tester at which the corresponding reference torque value is determined from the torque applied by the electronic torque wrench to the torque tester.

Clause 11. The apparatus of clause 10, wherein the apparatus is embodied as a computer, the sequence of digital data points and the torque value are read from the electronic torque wrench, and the calibration function is written to the electronic torque wrench, over a first data link between the electronic torque wrench and the computer, and wherein the corresponding reference torque value is read from the torque tester, over a second data link between the torque tester and the computer.

Clause 12. A method of calibrating a torque measurement device configured to produce a digital electrical signal that represents an applied torque as sequence of digital data points, and determine a torque value of the applied torque from the sequence of digital data points, the method comprising: reading the sequence of digital data points and the torque value from the torque measurement device; determining the torque measurement device is out of specification in that the torque value differs from a corresponding reference torque value by more than a threshold value; and in response, deriving a calibration function from the sequence of digital data points and the corresponding reference torque value; and writing the calibration function to the torque measurement device.

Clause 13. The method of clause 12, wherein the torque measurement device is configured to determine the torque value from a first calibration function, and the calibration function as derived is a second calibration that is written to the torque measurement device on which the first calibration is overwritten by the second calibration function.

Clause 14. The method of clause 13, wherein the torque measurement device configured to determine the torque value includes the torque measurement device configured to convert the sequence of digital data points to a digital value, and determine the torque value from the first calibration function that maps the digital value to the torque value.

Clause 15. The method of any of clauses 12 to 14, wherein deriving the calibration function includes: converting the sequence of digital data points to a digital value; and deriving the calibration function that maps the digital value to the corresponding reference value.

Clause 16. The method of clause 15, wherein converting the sequence of digital data points includes: determining a subset of the digital data points in a moving sample window; and calculating the digital value from a rolling average of the subset of the digital data points in the moving sample window.

Clause 17. The method of any of clauses 12 to 16, wherein the sequence of digital data points and the torque value are read for a plurality of applied torques across a rated torque range of the torque measurement device, and the calibration function is derived from the sequence of digital data points and corresponding reference torque values for the plurality of applied torques.

Clause 18. The method of any of clauses 12 to 17, wherein the torque measurement device is an electronic torque wrench, the applied torque is a torque applied by the electronic torque wrench to a torque tester with which the electronic torque wrench is engaged, and the method is performed by the torque tester.

Clause 19. The method of clause 18, wherein the sequence of digital data points and the torque value are read from the electronic torque wrench, and the calibration function is written to the electronic torque wrench, over a data link between the electronic torque wrench and the torque tester.

Clause 20. The method of clause 18 or clause 19, wherein the method further comprises: measuring the torque at the torque tester; and determining the corresponding reference torque value from the torque as measured.

Clause 21. The method of any of clauses 12 to 20, wherein the torque measurement device is an electronic torque wrench, the applied torque is a torque applied by the electronic torque wrench to a torque tester with which the electronic torque wrench is engaged, and the method further comprises: reading the corresponding reference torque value from the torque tester at which the corresponding reference torque value is determined from the torque applied by the electronic torque wrench to the torque tester.

Clause 22. The method of clause 21, wherein the method is performed by a computer, the sequence of digital data points and the torque value are read from the electronic torque wrench, and the calibration function is written to the electronic torque wrench, over a first data link between the electronic torque wrench and the computer, and wherein the corresponding reference torque value is read from the torque tester, over a second data link between the torque tester and the computer.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for calibrating a torque measurement device configured to produce a digital electrical signal that represents an applied torque as sequence of digital data points, and determine a torque value of the applied torque from the sequence of digital data points, the apparatus comprising:
a memory configured to store computer-readable program code; and
processing circuitry configured to access the memory, and execute the computer-readable program code to cause the apparatus to at least:
read the sequence of digital data points and the torque value from the torque measurement device;
determine the torque measurement device is out of specification in that the torque value differs from a corresponding reference torque value by more than a threshold value; and in response,
derive a calibration function from the sequence of digital data points and the corresponding reference torque value; and
write the calibration function to the torque measurement device.

2. The apparatus of claim 1, wherein the torque measurement device is configured to determine the torque value from a first calibration function, and the calibration function as derived is a second calibration that is written to the torque measurement device on which the first calibration is overwritten by the second calibration function.

3. The apparatus of claim 2, wherein the torque measurement device configured to determine the torque value includes the torque measurement device configured to convert the sequence of digital data points to a digital value, and determine the torque value from the first calibration function that maps the digital value to the torque value.

4. The apparatus of claim 1, wherein the apparatus caused to derive the calibration function includes the apparatus caused to:
convert the sequence of digital data points to a digital value; and
derive the calibration function that maps the digital value to the corresponding reference value.

5. The apparatus of claim 1, wherein the sequence of digital data points and the torque value are read for a plurality of applied torques across a rated torque range of the torque measurement device, and the calibration function is derived from the sequence of digital data points and corresponding reference torque values for the plurality of applied torques.

6. The apparatus of claim 1, wherein the torque measurement device is an electronic torque wrench, the applied torque is a torque applied by the electronic torque wrench to a torque tester with which the electronic torque wrench is engaged, and the apparatus is embodied as the torque tester.

7. The apparatus of claim 6, wherein the sequence of digital data points and the torque value are read from the electronic torque wrench, and the calibration function is written to the electronic torque wrench, over a data link between the electronic torque wrench and the torque tester.

8. The apparatus of claim 6, wherein the processing circuitry is configured to execute the computer-readable program code to cause the apparatus to further at least:
measure the torque at the torque tester; and
determine the corresponding reference torque value from the torque as measured.

9. The apparatus of claim 1, wherein the torque measurement device is an electronic torque wrench, the applied torque is a torque applied by the electronic torque wrench to a torque tester with which the electronic torque wrench is engaged, and the processing circuitry is configured to execute the computer-readable program code to cause the apparatus to further at least:
read the corresponding reference torque value from the torque tester at which the corresponding reference torque value is determined from the torque applied by the electronic torque wrench to the torque tester.

10. The apparatus of claim 9, wherein the apparatus is embodied as a computer, the sequence of digital data points and the torque value are read from the electronic torque wrench, and the calibration function is written to the electronic torque wrench, over a first data link between the electronic torque wrench and the computer, and
wherein the corresponding reference torque value is read from the torque tester, over a second data link between the torque tester and the computer.

11. A method of calibrating a torque measurement device configured to produce a digital electrical signal that represents an applied torque as sequence of digital data points, and determine a torque value of the applied torque from the sequence of digital data points, the method comprising:
reading the sequence of digital data points and the torque value from the torque measurement device;
determining the torque measurement device is out of specification in that the torque value differs from a corresponding reference torque value by more than a threshold value; and in response,
deriving a calibration function from the sequence of digital data points and the corresponding reference torque value; and
writing the calibration function to the torque measurement device.

12. The method of claim 11, wherein the torque measurement device is configured to determine the torque value from a first calibration function, and the calibration function as derived is a second calibration that is written to the torque measurement device on which the first calibration is overwritten by the second calibration function.

13. The method of claim 12, wherein the torque measurement device configured to determine the torque value includes the torque measurement device configured to convert the sequence of digital data points to a digital value, and determine the torque value from the first calibration function that maps the digital value to the torque value.

14. The method of claim 11, wherein deriving the calibration function includes:
converting the sequence of digital data points to a digital value; and
deriving the calibration function that maps the digital value to the corresponding reference value.

15. The method of claim 11, wherein the sequence of digital data points and the torque value are read for a plurality of applied torques across a rated torque range of the torque measurement device, and the calibration function is derived from the sequence of digital data points and corresponding reference torque values for the plurality of applied torques.

16. The method of claim 11, wherein the torque measurement device is an electronic torque wrench, the applied torque is a torque applied by the electronic torque wrench to a torque tester with which the electronic torque wrench is engaged, and the method is performed by the torque tester.

17. The method of claim 16, wherein the sequence of digital data points and the torque value are read from the electronic torque wrench, and the calibration function is written to the electronic torque wrench, over a data link between the electronic torque wrench and the torque tester.

18. The method of claim 16, wherein the method further comprises:
measuring the torque at the torque tester; and
determining the corresponding reference torque value from the torque as measured.

19. The method of claim 11, wherein the torque measurement device is an electronic torque wrench, the applied torque is a torque applied by the electronic torque wrench to a torque tester with which the electronic torque wrench is engaged, and the method further comprises:
reading the corresponding reference torque value from the torque tester at which the corresponding reference torque value is determined from the torque applied by the electronic torque wrench to the torque tester.

20. The method of claim 19, wherein the method is performed by a computer, the sequence of digital data points and the torque value are read from the electronic torque wrench, and the calibration function is written to the electronic torque wrench, over a first data link between the electronic torque wrench and the computer, and
wherein the corresponding reference torque value is read from the torque tester, over a second data link between the torque tester and the computer.
